(19) United States
(12) Patent Application Publication
(10) Pub. No.: US 2011/0079567 A1
(43) Pub. Date: Apr. 7, 2011

(54) Rotatable Shelf

(76) Inventor: Trena Anderson, Katy, TX (US)

(21) Appl. No.: 12/571,811

(22) Filed: Oct. 1, 2009

(51) Int. Cl. A47F 5/02; E06C 1/00

(52) U.S. Cl. 211/144; 182/129

(57) ABSTRACT

To more easily allow storage of removable products, e.g. soft drinks, bulk items, and the like, on a shelf that can be maneuvered into and out from storage places where space may be at a premium, a first embodiment of a rotatable shelf comprises a base having an upper surface and a lower surface; a spindle attached to the center of the base; a plurality of wheels attached to the lower surface of the base; a plurality of load support bearings attached at predetermined positions on the upper surface of the base; and a platform having substantially the same length and width dimensions of the base. The platform is rotatably attached to the spindle and disposed on the load support bearings substantially parallel to a horizontal plane defined by the upper surface of the base. In other embodiments, a plurality of platforms may be present.

### FIELD OF THE INVENTION

The invention relates to shelving for display and storage of removable products. More particularly, embodiments of the shelving relate to rotatable shelving which can be maneuvered into a storage place and out from the storage place for ease of accessing the removable products.

### BACKGROUND OF THE INVENTION

Removable products, e.g. soft drinks, bulk items, and the like, are often stored and/or displayed in fixed places such as on pallets. These fixed storage shelves are not easily maneuvered into and out from storage places where space may be at a premium. For example, in numerous small stores such as convenience stores, storage space is typically tight and valuable.

Moreover, products such as soft drinks, bulk items, and the like can weigh, in the aggregate, hundreds of pounds, making it necessary to have some form of augmented handler. Currently, a pallet is brought into the storage area with augmented handlers such as with a fork lift or pallet mover, either of which is, itself, cumbersome, bulky, and difficult to maneuver.

Once stored in place, it is often desirable to selectively retrieve products from the storage area shelf and often such retrieval is difficult because the product may be inaccessible or virtually inaccessible without moving the shelf from its storage place, e.g. to get to product stored towards the rear of the shelf.

### BRIEF DESCRIPTION OF THE DRAWINGS

The various drawings supplied herein are representative of one or more embodiments of the present inventions

FIG. 1 is a first view in partial perspective of a first embodiment of a rotatable shelf;

FIG. 2 is a second view in partial perspective of the first embodiment of a rotatable shelf showing its platform in a turned position;

FIG. 3 is a top schematic view of the first embodiment of a rotatable shelf;

FIG. 4 is a side schematic view of the first embodiment of a rotatable shelf;

FIG. 5 is a view in partial perspective of the first embodiment of a rotatable shelf illustrating an exemplary handle in an extended position;

FIG. 6 is view in partial perspective of the exemplary handle in an upright, extended position;

FIG. 7 is a bottom view in partial perspective of the first embodiment of a rotatable shelf;

FIG. 8 is a first view in partial perspective of a second embodiment of a rotatable shelf; and

FIG. 9 is a schematic side view in of a third embodiment of a rotatable shelf.

### DETAILED DESCRIPTION OF PREFERRED EMBODIMENTS

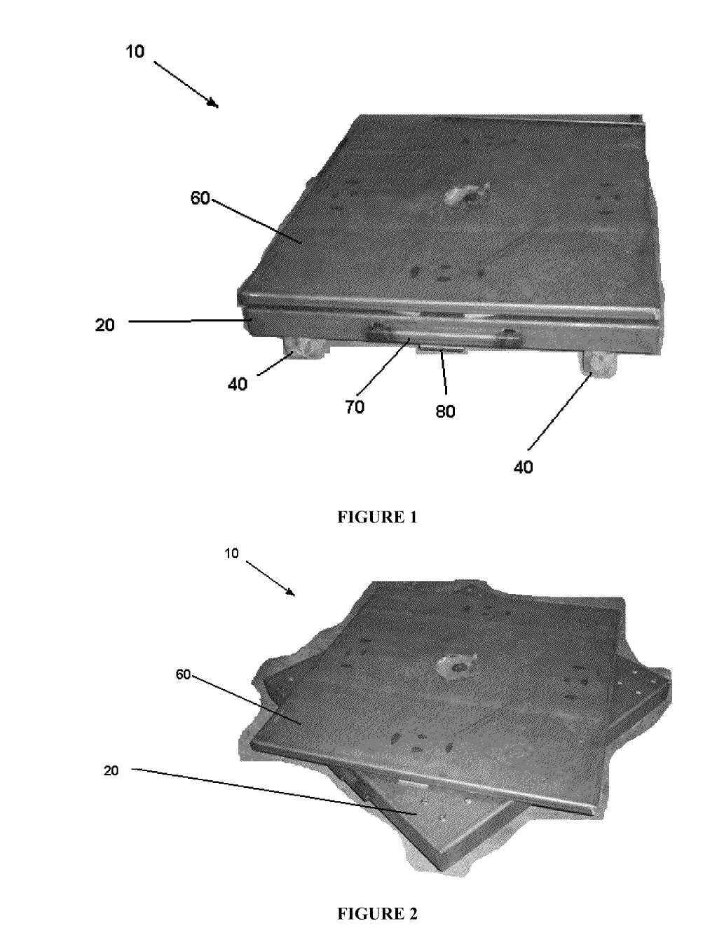

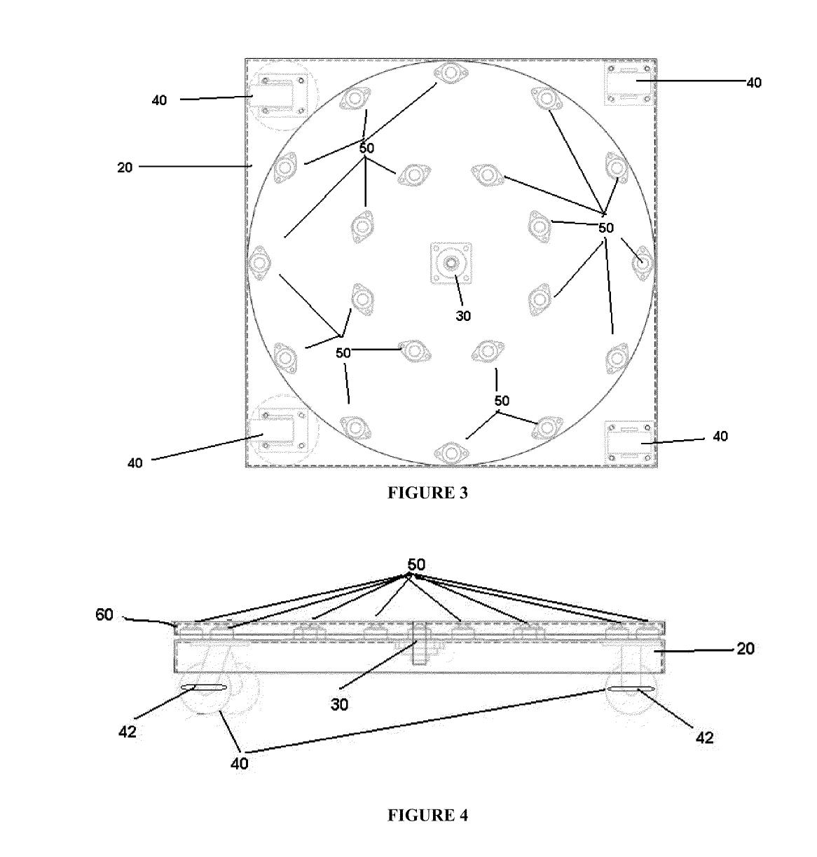

Referring now to FIGS. 1 and 2, rotatable shelf 10 comprises base 20, which, in preferred embodiments, is substantially square; spindle 30 (FIG. 3) attached to the center of base 20; a plurality of wheels 40 attached to a lower surface of base 20; a plurality of load support bearings 50 (FIG. 3) attached at predetermined positions on an upper surface of base 20; and platform 60.

In its preferred embodiments, base 20 and/or platform 60 are dimensioned to accept an industry standard pallet and rotatable shelf 10 comprises a material such that base 20, load support bearings 50, and platform 60 can support a load of around 2800 pounds. Although its preferred embodiment is substantially square, base 20 can be of different shapes, e.g. circular or oval. Base 20 may be constructed out of suitable metals, plastics, and the like, or a combination thereof to support the required weight of products stored on rotatable shelf 10 which is typically up to around 2800 pounds.

Platform 60 typically has substantially the same length and width dimensions of base 20 and is further attached to spindle 30 (FIGS. 3 and 4) to allow rotation with respect to base 20 and/or spindle 30. Platform 60 is disposed on load support bearings 50 (FIGS. 3 and 4) substantially parallel to a horizontal plane defined by the upper surface of base 20. Platform 60 may be constructed out of suitable metals, plastics, and the like, or a combination thereof to support the required weight which is typically around 2800 pounds.

Referring additionally to FIGS. 3 and 4, spindle 30 is rotatable about a vertical axis with respect to the horizontal plane defined by the upper surface of base 20. The plurality of load support bearings 50 is most typically attached at predetermined positions on an upper surface of base 20 such as disposed in a substantially concentric circular pattern about spindle 30 or in a plurality of substantially concentric circular patterns about spindle 30.

In certain embodiments, platform 60 may further comprise bearing 62 disposed about an outer surface of spindle 30, thus allowing platform 60 to rotate about vertical axis 24 with respect to a horizontal plane defined by the upper surface of base 20.

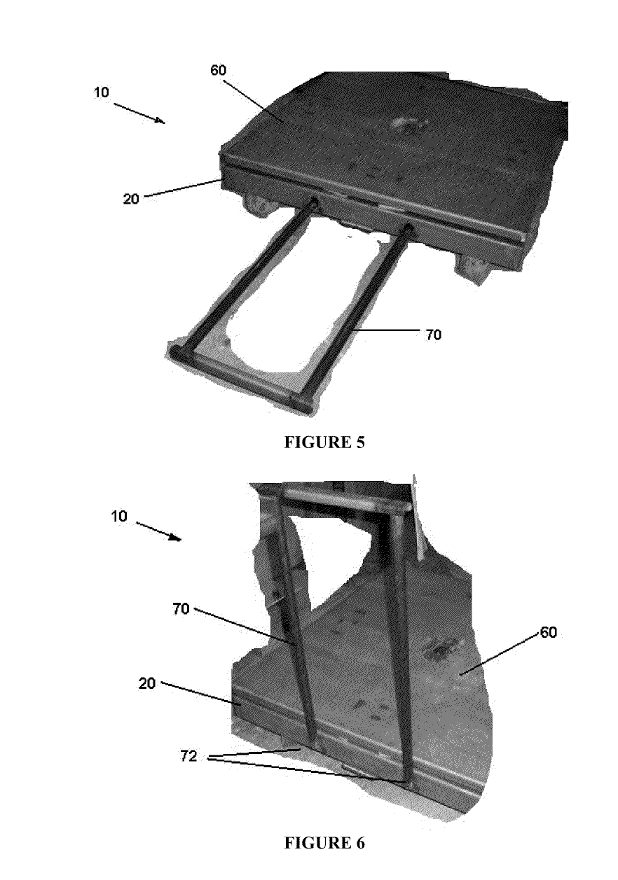

Referring additionally to FIGS. 5 and 6, selectively extendable handle 70 may be present and dimensioned and configured to allow a human being to maneuver rotatable shelf 10 on its wheels 40. Handle 70 is typically dimensioned and configured to be retrievably stored underneath the base, e.g. it may be comprise single sides 72 or sides 72 may be telescoping and collapsing. Handle 70 may be withdrawn a predetermined distance from within base 20 and pivoted about pivot points 72.

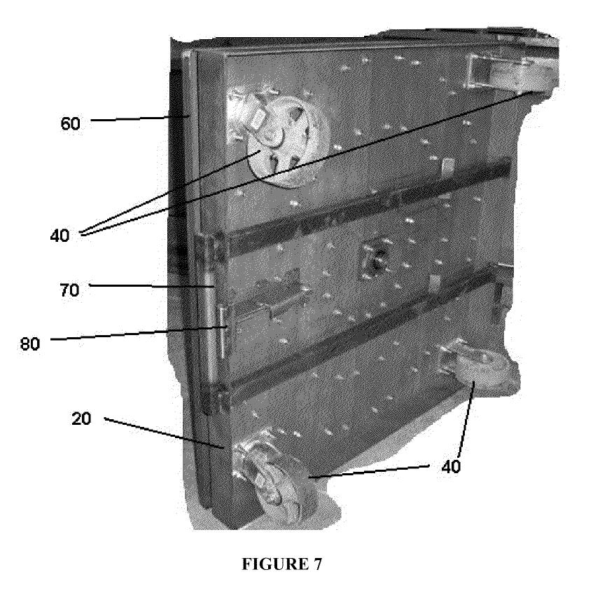

Referring additionally to FIG. 7, brake 80 may be present and dimensioned and adapted to selectively engage platform 60 and prevent motion of platform 60 about spindle 30. Brake 42 (FIG. 4) may also be present at one or more wheels 40 to allow or prevent motion of wheels 40.

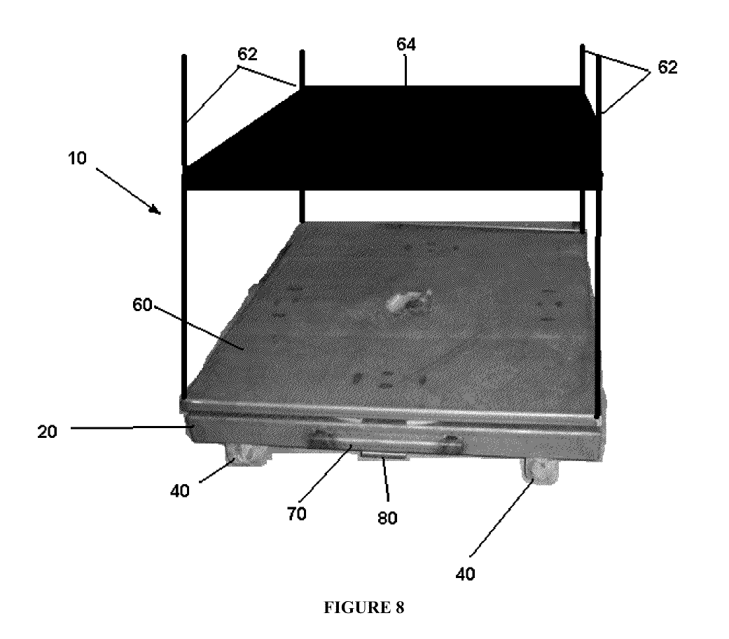

Referring to FIG. 8, in a further contemplated embodiment, rotatable shelf 10 further comprises a plurality of supports 62 attached to the periphery of base 20 substantially perpendicular to a horizontal plane defined by the upper surface of base 20, where at least two of supports 62 define a substantially open side parallel to and in between supports 62. One or more additional second platforms 64, each having substantially the same length and width dimensions of platform 60, are fixedly and/or removably attached to one or more of the plurality of supports 62. Each second platform 62 may be constructed out of suitable metals, plastics, and the like, or a combination thereof to support the required weight which is typically around 2800 pounds.

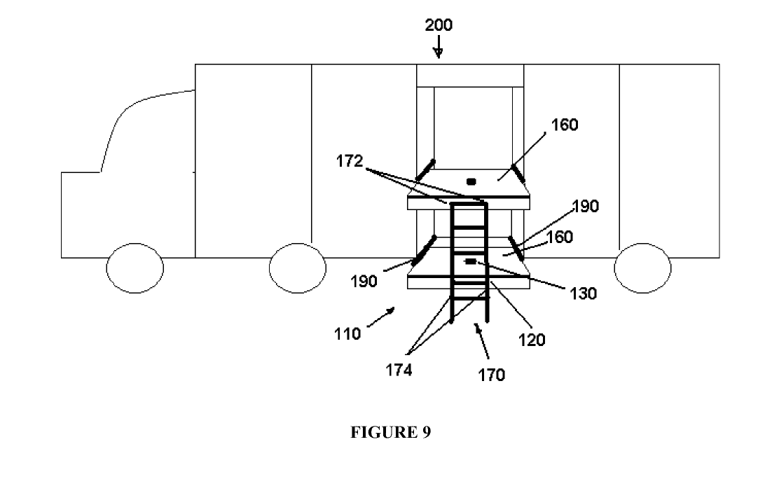

Referring to FIG. 9, in a further embodiment, rotatable shelf 110 comprises a substantially square base 120; spindle 130 attached to the center of base 120; one or more supports 190 dimensioned and configured to allow base 120 to be slidably mounted within storage bay 200; a plurality of load support bearings 150 (not shown in the figures but similar to bearings 50 shown in FIG. 3) attached at predetermined positions on an upper surface of base 120; and platform 160 having substantially the same length and width dimensions of base 120. Storage bay 200 may be a free standing storage bay such as in a warehouse or the like, or can be a storage bay in a vehicle such as a delivery vehicle as illustrated in FIG. 9.

In this embodiment, platform 160 is rotatably attached to spindle 130 and disposed on load support bearings 150 (not shown in the figures but similar to bearings 50 shown in FIG. 3) substantially parallel to a horizontal plane defined by the upper surface of base 120. Platform 160 may be constructed out of suitable metals, plastics, and the like, or a combination thereof to support the required weight which is typically around 2800 pounds.

Base 120 and platform 160 are dimensioned to accept an industry standard pallet.

Spindle 130 is rotatable about a vertical axis with respect to the horizontal plane defined by the upper surface of base 120.

Platform 160 typically further comprises bearing 162 (not shown in the figures but similar to bearing 62 shown in FIG. 3) disposed about an outer surface of spindle 130, thus allowing platform 160 to be rotatable about a vertical axis with respect to a horizontal plane defined by the upper surface of base 120.

The plurality of load support bearings 140 (not shown in the figures but similar to bearings 40 shown in FIG. 3) are attached at predetermined positions on an upper surface of base 120 and may be disposed in one or more substantially concentric circular patterns about spindle 130.

Selectively extendable ladder 170 may be present where ladder 170 is dimensioned and configured to be retrievably stored underneath base 120. Handle 170 is typically dimensioned and configured to be retrievably stored underneath base 120, e.g. it may be comprise single sides 174 or sides 174 may be telescoping and collapsing. In currently envisioned embodiments, ladder 170 is further dimensioned and configured to provide support for base 120 in a predetermined plane relative to base 120. By way of example and not limitation, handle 170, once extended, may be pivoted about pivot point 172 such that it provides a support between base 120 and, e.g., the ground.

Brake 180 (not shown in the figures but similar to brake 80 shown in FIG. 5) may be present to selectively engage platform 160 to prevent motion of platform 160 about spindle 130.

In the operation of preferred embodiments, referring generally to FIGS. 1-7, rotatable shelf 10 may be maneuvered into a desired position, either containing some or no material on platform 60, by releasing one or more brakes 80 and rolling rotatable shelf 10 into the desired position. Handle 70 may be used to aid in the maneuvering. Once present, one or more brakes 42,80 may then be engaged to keep rotatable shelf 10 in place. If handle 70 was used, it can be stored back into base 20 after rotatable shelf 10 is in its desired place. Materials, e.g. bottles, cans, packages, and the like, may be moved onto or off of platform 60. If material is unreachable, one or more brakes 80,42 may then be disengaged and rotatable shelf 10 moved, allowing rotation of rotatable shelf 10 about either bearing 30, movable feet 40, or a combination thereof, into a new position for reinsertion into its desired space or simply to allow access to the materials. This method is the same with or without supports 62 and second platforms 64.

Referring generally to FIG. 9, in a further embodiment, rotatable shelf 110 may be inserted into or retried from storage bay 200 using supports 190 to slidably move base 120 within storage bay 200.

Once retrieved from storage bay 200 into an extended position, base 120 may be supported by supports 190, handle 170, or the like, or a combination thereof. In its extended position, platform 160 may be rotated about spindle 130 to allow access to materials stored on platform 160 or to space on platform 160 on which to store materials.

The foregoing disclosure and description of the inventions are illustrative and explanatory. Various changes in the size, shape, and materials, as well as in the details of the illustrative construction and/or a illustrative method may be made without departing from the spirit of the invention.

What is claimed is:

1. A rotatable shelf, comprising:
a. a base having an upper surface and a lower surface;
b. a spindle attached to the center of the base;
c. a plurality of wheels attached to the lower surface of the base;
d. a plurality of load support bearings attached at predetermined positions on the upper surface of the base; and
e. a platform having substantially the same length and width dimensions of the base, the platform rotatably attached to the spindle and disposed on the load support bearings substantially parallel to a horizontal plane defined by the upper surface of the base.

2. The rotatable shelf of claim 1, wherein the base is substantially square.

3. The rotatable shelf of claim 1, wherein the base, load support bearings, and platform are dimensioned and configured to support a load of around 2800 pounds.

4. The rotatable shelf of claim 1, wherein the platform is rotatable about the spindle along a vertical axis through the spindle with respect to the horizontal plane defined by the upper surface of the base.

5. The rotatable shelf of claim 4, wherein the platform further comprises a bearing disposed about an outer surface of the spindle.

6. The rotatable shelf of claim 1, further comprising:
a. a plurality of supports attached about a periphery of the base substantially perpendicular to a horizontal plane defined by the upper surface of the base, two of the supports defining a substantially open side parallel to and in between the supports; and
b. a second platform having substantially the same length and width dimensions of the base, the second platform attached to one of the plurality of supports.

7. The rotatable shelf of claim 1, further comprising a selectively extendable handle dimensioned and configured to allow a human being to maneuver the rotatable shelf on its wheels.

8. The rotatable shelf of claim 7, wherein:
a. the handle is dimensioned and configured to be retrievably stored underneath the base; and
b. the handle is pivotable about a pivot point in the base.

9. The rotatable shelf of claim 1, wherein the plurality of load support bearings are attached at predetermined positions on the upper surface of the base and disposed in a substantially concentric circular pattern about the spindle.

10. The rotatable shelf of claim 9, wherein the substantially concentric circular pattern comprises a plurality of substantially concentric circular patterns.

11. The rotatable shelf of claim 1, further comprising a brake dimensioned and adapted to selectively engage the platform and prevent motion of the platform about the spindle.

12. The rotatable shelf of claim 1, wherein the base is dimensioned to accept an industry standard pallet.

13. A rotatable shelf, comprising:
a. a base having an upper surface and a lower surface;
b. a spindle attached to the center of the base;
c. a support attached to the base and dimensioned and configured to allow the base to be slidably mounted within a storage bay;
d. a plurality of load support bearings attached at predetermined positions on the upper surface of the base; and
e. a platform having substantially the same length and width dimensions of the base, the platform rotatably attached to the spindle and disposed on the load support bearings substantially parallel to a horizontal plane defined by the upper surface of the base.

14. The rotatable shelf of claim 13, wherein the base is substantially square.

15. The rotatable shelf of claim 13, further comprising a selectively extendable ladder, the ladder dimensioned and configured to be retrievably stored underneath the base.

16. The rotatable shelf of claim 15, wherein the ladder is further dimensioned and configured to provide support for the base in a predetermined plane relative to the base.

17. The rotatable shelf of claim 15, wherein the ladder is further dimensioned and configured to pivot about a pivot point disposed about the base.

18. The rotatable shelf of claim 13, wherein the platform is rotatable about the spindle along a vertical axis through the spindle with respect to the horizontal plane defined by the upper surface of the base.

19. The rotatable shelf of claim 18, wherein the platform further comprises a bearing disposed about an outer surface of the spindle.

20. The rotatable shelf of claim 13, wherein the plurality of load support bearings are attached at predetermined positions on the upper surface of the base and disposed in a substantially concentric circular pattern about the spindle.

21. The rotatable shelf of claim 20, wherein the substantially concentric circular pattern comprises a plurality of substantially concentric circular patterns.

22. The rotatable shelf of claim 13, further comprising a brake dimensioned and adapted to selectively engage the platform and prevent motion of the platform about the spindle.

23. The rotatable shelf of claim 13, wherein the base is dimensioned to accept an industry standard pallet.
